(19) United States
(12) Patent Application Publication
(10) Pub. No.: US 2025/0317467 A1
(43) Pub. Date: Oct. 9, 2025

(54) SYSTEMS AND METHODS FOR TRAINING MACHINE-LEARNING MODELS ON ATTACK PATHS

(71) Applicant: Cisco Technology, Inc., San Jose, CA (US)

(72) Inventors: Hendrikus G. P. Bosch, Aalsmeer (NL); Andre Jean Marie Surcouf, Saint Leu La Foret (FR); Gafnit Amiga, Petah Tikva (IL); Alessandro Duminuco, Milano (IT); Jeffrey Michael Napper, Delft (NL); Ronan Oostveen, Montfoort (NL)

(21) Appl. No.: 19/097,511

(22) Filed: Apr. 1, 2025

Related U.S. Application Data
(60) Provisional application No. 63/631,843, filed on Apr. 9, 2024.

(51) Int. Cl. H04L 9/40; H04L 41/16

(52) U.S. Cl. CPC H04L 63/1433; H04L 41/16

(57) ABSTRACT

In an embodiment, a method includes analyzing an application to determine its assets and topologies, executing a machine-learning model over the assets and topologies to predict logical attack paths and physical attack paths associated with each of the logical attack paths, wherein the physical attack paths associated with each of the logical attack paths map to that logical attack path, wherein each of the physical attack paths includes a respective set of physical assets of the application that can be used in a real-world attack, wherein each of the logical attack paths includes a sequence of logical steps of the real-world attack, and wherein the machine-learning model was trained based on training physical attack paths, training logical attack paths, and correlations between the training physical attack paths and training logical paths, and transmitting the predicted physical attack paths and the predicted logical attack paths to monitoring systems for display.

### PRIORITY

This application claims the benefit, under 35 U.S.C. § 119 (e), of U.S. Provisional Patent Application No. 63/631,843, filed Apr. 9, 2024, which is incorporated herein by reference.

### TECHNICAL FIELD

This disclosure generally relates to attack paths, and in particular relates to systems and methods for training machine-learning models on attack paths.

### BACKGROUND

A cyberattack (or cyber-attack) occurs when an unauthorized action against computer infrastructure compromises the confidentiality, integrity, or availability of its content. A cyberattack can be defined as any attempt by an individual or organization using computers and computer systems to steal, expose, change, disable, or eliminate information or to breach computer information systems, computer networks, and computer infrastructures.

### BRIEF DESCRIPTION OF THE DRAWINGS

FIG. 1 illustrates a system for training machine-learning models on attack paths, in accordance with certain embodiments.

FIG. 2 illustrates an attack path, in accordance with certain embodiments.

FIGS. 3A-3B illustrate examples of physical attack paths, in accordance with certain embodiments.

FIG. 4 illustrates a method for training a machine-learning model and using the trained machine-learning model to predict attack paths, in accordance with certain embodiments.

FIG. 5 illustrates a computer system, in accordance with certain embodiments.

### DESCRIPTION OF EXAMPLE EMBODIMENTS

### Overview

According to an embodiment, a system may include one or more processors and one or more computer-readable non-transitory storage media comprising instructions that, when executed by the one or more processors, cause one or more components of the system to perform operations. The operations may include analyzing an application to determine a plurality of assets associated with the application and a plurality of topologies associated with the application. The operations may also include executing a machine-learning model over the plurality of assets and the plurality of topologies to predict one or more logical attack paths and one or more physical attack paths associated with each of the one or more logical attack paths. The predicted one or more physical attack paths associated with each of the one or more predicted logical attack paths may map to that predicted logical attack path. Each of the predicted one or more physical attack paths may include a respective set of physical assets of the application that can be used in a real-world attack. Each of the predicted one or more logical attack paths may include a sequence of logical steps of the real-world attack. The machine-learning model may be trained based on a plurality of training physical attack paths, a plurality of training logical attack paths, and correlations between the plurality of training physical attack paths and the plurality of training logical paths. The operations may further include transmitting the predicted one or more logical attack paths and the predicted one or more physical attack paths associated with each of the predicted logical attack paths to one or more monitoring systems for display.

In certain embodiments, each of the predicted one or more physical attack paths and the predicted one or more logical attack paths may be associated with a respective probability inferred by the machine-learning model.

In certain embodiments, the operations may further include generating, by the machine-learning model based on the respective probability associated with each of the predicted one or more physical attack paths and the predicted one or more logical attack paths, a recommendation for prioritizing one or more of the predicted one or more physical and the predicted one or more logical attack paths.

In certain embodiments, the operations may further include generating, by the machine-learning model based on the respective probability associated with each of the predicted one or more physical attack paths and the predicted one or more logical attack paths, a recommendation for remediating one or more of the predicted one or more physical and the predicted one or more logical attack paths.

In certain embodiments, the plurality of training physical attack paths and the plurality of training logical attack paths may include a plurality of pre-calculated attack paths and a plurality of auto-generated attack paths. The operations may include generating the plurality of pre-calculated attack paths based on analyses of vulnerabilities associated with a plurality of applications. The operations may also include generating the plurality of auto-generated attack paths based on public sources. The operations may further include determining correlations between the plurality of pre-calculated attack paths and the plurality of auto-generated attack paths. The correlations between the plurality of training physical attack paths and the plurality of training logical paths may include the correlations between the plurality of pre-calculated attack paths and the plurality of auto-generated attack paths.

In certain embodiments, the predicted logical attack path may include a sequence of logical steps. The sequence of logical steps may include accessing an application programming interface (API) associated with the application via an API endpoint of the application. The sequence of logical steps may further include accessing a data source comprising sensitive data, wherein the data source is managed by the application.

In certain embodiments, the predicted one or more logical attack paths may include a first logical attack path and one or more second logical attack paths. The first logical attack path may include a first sequence of logical steps. Each of the second logical attack paths may include a respective second sequence of logical steps. At least one of the logical steps between any two second sequences of logical steps may be different. At least one of the logical steps of the first sequence of logical steps and one of each second sequence of logical steps may be a same logical step. A combination of the logical steps of the second sequences of logical steps may include the logical steps of the first sequence of logical steps.

According to another embodiment, a method may include analyzing an application to determine a plurality of assets associated with the application and a plurality of topologies associated with the application. The method may also include executing a machine-learning model over the plurality of assets and the plurality of topologies to predict one or more logical attack paths and one or more physical attack paths associated with each of the one or more logical attack paths. The predicted one or more physical attack paths associated with each of the one or more predicted logical attack paths may map to that predicted logical attack path. Each of the predicted one or more physical attack paths may include a respective set of physical assets of the application that can be used in a real-world attack. Each of the predicted one or more logical attack paths may include a sequence of logical steps of the real-world attack. The machine-learning model may be trained based on a plurality of training physical attack paths, a plurality of training logical attack paths, and correlations between the plurality of training physical attack paths and the plurality of training logical paths. The method may further include transmitting the predicted one or more logical attack paths and the predicted one or more physical attack paths associated with each of the predicted logical attack paths to one or more monitoring systems for display.

According to yet another embodiment, one or more computer-readable non-transitory storage media may embody instructions that, when executed by a processor, cause the performance of operations. The operations may include analyzing an application to determine a plurality of assets associated with the application and a plurality of topologies associated with the application. The operations may also include executing a machine-learning model over the plurality of assets and the plurality of topologies to predict one or more logical attack paths and one or more physical attack paths associated with each of the one or more logical attack paths. The predicted one or more physical attack paths associated with each of the one or more predicted logical attack paths may map to that predicted logical attack path. Each of the predicted one or more physical attack paths may include a respective set of physical assets of the application that can be used in a real-world attack. Each of the predicted one or more logical attack paths may include a sequence of logical steps of the real-world attack. The machine-learning model may be trained based on a plurality of training physical attack paths, a plurality of training logical attack paths, and correlations between the plurality of training physical attack paths and the plurality of training logical paths. The operations may further include transmitting the predicted one or more physical attack paths associated with each of the predicted logical attack paths to one or more monitoring systems for display.

Technical advantages of certain embodiments of this disclosure may include one or more of the following. Certain systems and methods described herein may perform an attack-path analysis that devolves into the task of inference in neural networks. Certain embodiments of this disclosure may generate a task that can be executed efficiently with current vector processing techniques (e.g., as based on graphics processing units (GPUs)). New attack paths can be easily introduced by expanding the training set with newly crafted logical and physical attack paths and not requiring a massive engineering effort, dramatically increasing the speed by which new paths can be introduced into vulnerability scanning tooling. In application security, solving the visibility problem is the essential problem. Although remediation of application vulnerabilities is important, just knowing where the vulnerabilities are is more important than having these vulnerabilities automatically fixed. In other words, the problem for application security is a visibility problem. Certain systems and methods described herein may improve the visibility of all possible attack paths compared to conventional deterministic approaches. In addition, resolving vulnerabilities of all possible attack paths can be overwhelming for resources. Certain systems and methods described herein may help prioritize predicted attack paths based on their inferred probabilities. With a prioritized list of attack paths, resources can be saved, and vulnerabilities can be efficiently resolved.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

Attack paths are steps (e.g., a sequence) an attacker can take to gain unauthorized access to an application. These attack paths may start with an initial attack vector to access the application, followed by additional steps to search within the application. The searching within the application can involve a set of steps to deliver an application payload such that the attacker can connect directly to a program or function they downloaded into the application. The program or function can be to snoop on traffic inside the application, connect to and trampoline into other application components, etc. These types of attacks can steal central processing unit (CPU) information, graphics processing unit (GPU) information, etc., and create general mayhem inside the application to steal and misuse credentials and/or to mishandle data managed by the application.

Convention systems use a laborious process to find potential attack paths in an application. For example, a red team may analyze a set of new or existing cloud vulnerabilities and application vulnerabilities to understand better how attackers may use such vulnerabilities. A red team in cybersecurity refers to a group of ethical hackers who intentionally simulate real-world cyber-attacks against an organization to identify vulnerabilities in their security posture by acting like a potential adversary, essentially playing the role of the attacker to test the effectiveness of the organization's defenses and identify areas for improvement. Understanding how attackers may use such vulnerabilities may lead to an “attack-path pattern” that describes the elements that need to be present in the cloud assets and application assets for the application to become vulnerable. The attack-path pattern may represent a program that runs over an asset inventory to find credible attack paths. Each such attack-path type may be associated with an attack-path pattern. As the attack surface expands from finding attack paths in cloud vulnerabilities and application image vulnerabilities to include multiple aspects of the end-to-end application, including code pipelines, application programming interfaces (APIs), data sources and sinks, cloud infrastructure, large language models (LLMs) and more, the amount of research and engineering needed to keep up with attackers can become daunting.

Traditionally, an attack-path analysis may be performed by assessing cloud configuration and associated mishaps of an application and then combining the assessment with the application's images and vulnerabilities to determine before computing how attackers can misuse the application and cloud posture to access and search within the application. The attack-path computation may be performed by building one or more (vector) databases that describe relevant scanned assets, their vulnerabilities, and misconfigurations and using predefined patterns or attack-path programs to determine how attackers can attack. These patterns may represent programs that operate on the (vector) database.

An algorithmic attack-path analysis may involve building (vector) databases that capture the elements or assets an application uses. The elements or assets captured in the databases may be addressable (i.e., they can be identified or located) and reachable (i.e., they can be obtained and used). These elements or assets may include cloud-, image-, token-, data-, large language model (LLM)-, continuous integration and continuous delivery/deployment (CI/CD)-, and application programming interface (API) resources (risk dimensions) that may be combined with assessed vulnerabilities, misconfigurations, and other idiosyncratic states that attackers may use to access the application (from here-on called: vulnerabilities).

In certain embodiments, the algorithmic attack-path analysis may involve building (vector) databases that capture the relationships between these assets and the nature of those relationships and/or execute precisely formulated queries (patterns) against those databases to determine if an application is susceptible to an attack by stringing together vulnerabilities across the assets. Deciding how applications can be broken into using the entire attack surface of the applications and assessing the impact of those break-ins can be cumbersome. For example, this process may require extensive red-team research combined with extensive engineering efforts to build up the application's metadata and programs that operate on that metadata to determine susceptibility to attacks. Conventional attack-path analysis using traditional, algorithmic approaches is complex.

While a conventional attack-path analysis with just cloud assets and image security assets and vulnerabilities is already a complex operation, the attack surface has since dramatically increased. Scanning cloud resources and image resources may provide a limited view to attack-paths that attackers can explore. Attackers can use other ways to access the application, such as, but not limited to, broken CI/CD pipelines, exposed API services, malware hidden inside data repositories, tokens stored in log files and other available storage devices, and now emerging generative artificial intelligence (AI)-based chatbots or other generative AI (GenAI)-based artifacts that are deployed inside applications. Attackers may use generative AI techniques/models with attack techniques that allow them to combine attack techniques more automatically and thus enlarge their attack reach. As more applications are developed as cloud-native applications with an emphasis on the decomposition of the application and relying on third-party services more than before, the attack surface is increased even further.

This disclosure presents mechanisms and probabilistic methods for attack-path analysis using modern machine-learning techniques. The embodiments herein disclose a new approach to attack-path analysis. In certain embodiments, a security system may train machine-learning models on known attack paths and correlations between logical and physical attack paths. The security system may infer probabilistic attack paths and their probabilities from the trained machine-learning model. The security system may conduct reinforcement learning on inferred attack paths after analysis by red teams to optimize the machine-learning model further.

Instead of using deterministic methods to find potential attack paths across an asset inventory, the security system may train a deep neural-network (traditional or generative/transformative) model on known and new attack paths. Once trained, the machine-learning model itself may be used to generate or infer probabilistic attack paths. In certain embodiments, the machine-learning model may map physical application topologies onto logical attack paths. The machine-learning model may infer one or more potential, applicable, logical attack paths relative to the assets that operate on the physical attack paths. The probabilistic methods achieved by the machine-learning model can be used to improve security vulnerability products and find potential attack paths more effectively and efficiently relative to the conventional laborious processes.

Training the machine-learning model may be initiated with established, pre-calculated attack paths and expanded upon using additional information such as common vulnerabilities and exposures (CVEs), common weakness enumeration (CWE) descriptions, adversarial tactics, techniques, common knowledge descriptions, and the like. The power of the machine-learning model may include precisely finding logical attack paths across a vast search space of application assets (inclusive of infrastructural) without the need of crafting attack-path pattern programs, which is an improvement in terms of the engineering effort needed to craft attack paths across applications. Moreover, the machine-learning model may find more non-obvious attacks paths given the probabilistic nature of its operations. Red teams can leverage these non-obvious paths for further training of the machine-learning model.

The embodiments disclosed herein can ensure the machine-learning model captures one or more of the steps described above for an existing attack-path analysis and is then further trained with attack information gleaned from Internet resources, dark-web sites, (other) red teams, and the like. The machine-learning model may capture probabilistically the relationship between physical and logical attack paths. The physical attack paths represent actions attackers can take to break in, while the logical attack path presents this in an abstract form. Many physical attack paths can map to the same logical attack path. With the disclosed machine-learning model, determining if an application is susceptible to attacks can be a matter of finding the physical attack-path paths in the application topologies and translating those physical attack paths to their logical counterparts. Security personnel may then use those physical and logical attack paths for prioritization and remediation. Training the machine-learning model may be a task for current red teams. These teams may become curators of the machine-learning model and can more easily integrate, test, and acquire new attack paths. The embodiments disclosed herein may replace precisely formulated queries to craft attack paths against an asset database with the machine-learning model for finding probabilistic attack paths.

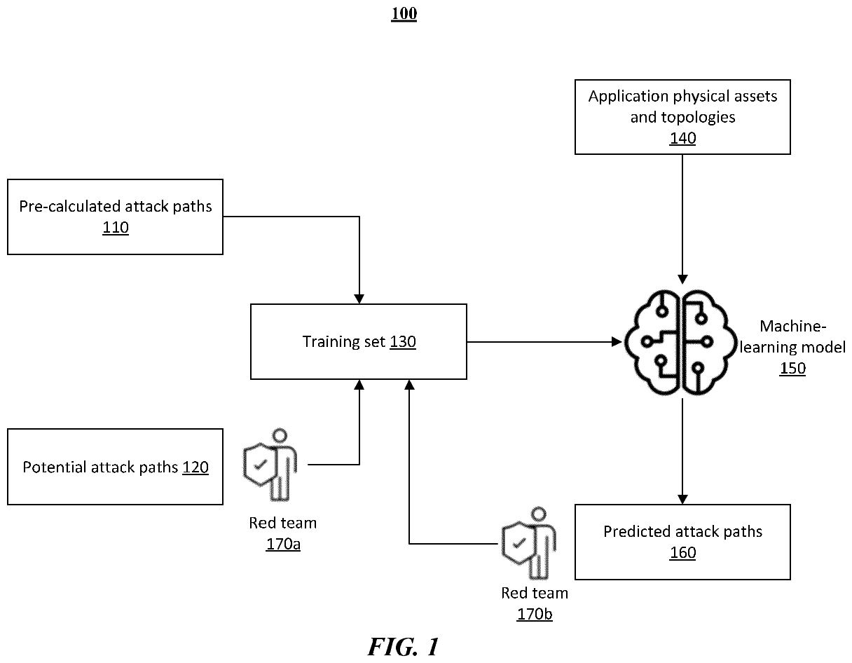

FIG. 1 illustrates a system 100 for training machine-learning models on attack paths, in accordance with certain embodiments. FIG. 1 shows a detailed overview of creating a training set and how inference works for predicting attack paths through the trained machine-learning model. The operation aims to train the machine-learning model as shown in FIG. 1 with the mappings between physical assets that are used for logical attack paths in a way that during inference the application's topology can be directly subjected to the machine-learning model.

Referencing FIG. 1, the process starts by accessing existing attack paths crafted via a traditional attack-path analysis. The security industry supports many vulnerability applications that can analyze an application and its used infrastructure and calculate attack paths based on those assets. These pre-calculated attack paths 110 can be included in a training set 130 (and testing set) for training the machine-learning model 150 shown in FIG. 1. The physical assets used for an attack path and its logical representation thereof may be provided to the machine-learning model 150 as a translation of one to the other.

Also referencing FIG. 1, attack paths can be generated through other automated means. For instance, techniques can be used to combine MITRE ATT&CK-based Tactics, Techniques and Procedures (TTPs), CVE and CWE database entries, and Cyber Threat Intelligence (CTI) reports into potential (logical and physical) attack paths 120. Blogs or other public material can be automatically converted into potential attack paths 120. These potential attack paths 120 are considered potential as there may be an expectation of a high false-positive rate. A red team 170a may classify and label those potential attack paths 120 to reduce the false positive rate. Like the traditional pre-calculated attack paths 110, these auto-generated potential attack paths 120 may be included in the training set 130 (and testing set) for training the machine-learning model 150.

Once the machine-learning model 150 is trained, application physical assets and topologies 140 may be subjected to the machine-learning model 150 to infer predicted attack paths 160. In certain embodiments, application physical assets may refer to the resources and files used by an application to function. For example, these assets may include media files (images, icons, videos, and audio files used within the application, configuration files, localization files, data files, scripts and libraries, etc. Application topologies may refer to the structural layout of an application, including how the application's components interact and are deployed across infrastructure. Application topologies may define the relationships between services, databases, APIs, frontends, and other elements within the application. Since the machine-learning model 150 is trained on the mappings of physical assets to logical assets, subjecting the application physical assets and topologies 140 to the machine-learning model 150 may infer one or more physical and logical attack paths that match the modeling with their matching probabilities.

To refine the training set 130 (and testing set) further, a red team 170b can classify and label the predicted attack paths 160.

In application security, solving the visibility problem is the essential problem. Although remediation is important, just knowing where the problems are is more important than having these problems automatically fixed. In other words, the security problem is a visibility problem.

Traditionally, visibility of attack paths is achieved by having deterministic programs go over an application topology to find an attack vector and path to break into the application. Assume that this attack path is the following: the attacker executes technique A, then once A is successfully complete, the attacker executes techniques B, C, and D to get access to a physical asset, e.g., a storage device. Conventional systems using deterministic programs may predict an attack path including a sequence of steps: executing technique A, executing technique B, executing technique C, and executing technique D. Assume that such deterministic programs may also predict an attack path including a sequence of steps: executing technique X, executing technique Y, executing technique C, and executing technique Z as a possible attack path. Such deterministic programs would fail to predict other permutations such as an attack path including a sequence of steps: executing technique A, executing technique B, executing technique C, and executing technique Z, and another attack path including a sequence of steps: executing technique X, executing technique Y, executing technique C, and executing technique D. By contrast, the embodiments disclosed herein (e.g., inference techniques through transformers) can infer more combinations, including a sequence of steps: executing technique A, executing technique B, executing technique C, and executing technique D, and other permutations. For example, these other attack paths failed to be predicted by conventional systems using deterministic programs may be predicted by the embodiments disclosed herein, likely with lower probabilities.

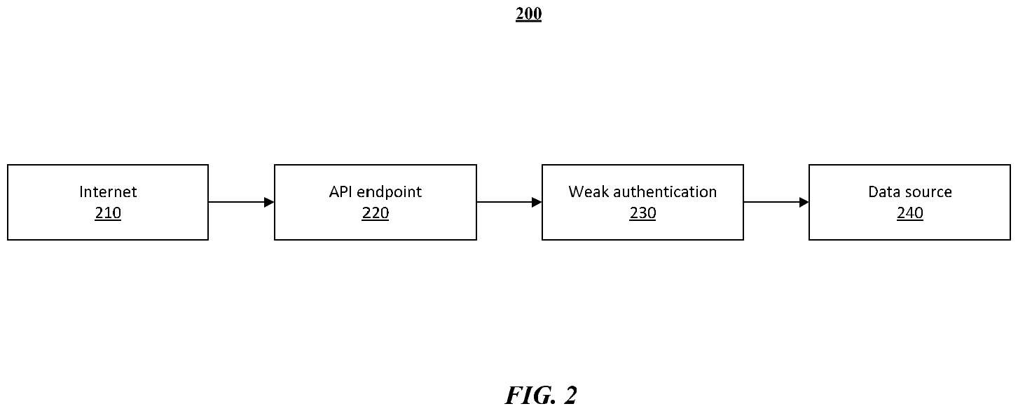

FIG. 2 illustrates a logical attack path 200, in accordance with certain embodiments. The logical attack path 200 of FIG. 2 may describe the steps to realize the disclosed embodiments in an attack-path analysis. The logical attack path 200 of FIG. 2 is one where an attacker can potentially attack an API service from the Internet 210. For example, the attacker may use an externally exposed API service by way of its API endpoint 220 (e.g., an associated verb (GET, PUT, . . . )) to gain access to a data source 240 carrying Personal Identifiable Information (PII) data. As presented in this logical attack path 200, the specific weakness may be that a weak authentication 230 method is used to access data source 240 managed by the API service. This unauthorized access can be a serious issue as the data being addressable is of type PII. In other words, an attacker from the Internet 210 can access an API endpoint 220 named https://api.foo.com/bar. The bearer authentication is weak, and PII data is exposed through that API endpoint 220.

The logical attack path 200, as presented in FIG. 2, may not be the precise path an attacker can use to access the PII. The logical attack path 200 in FIG. 2 is a logical attack path because it describes the logical steps the attacker takes. This logical attack path 200 may manifest itself in one or more physical attack paths. A physical attack path may include a set of physical assets that can be used in an actual attack.

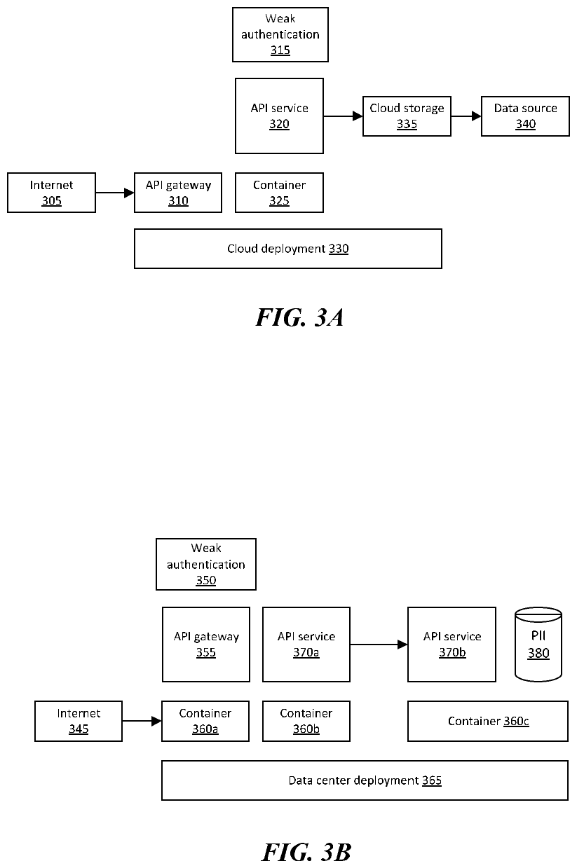

FIGS. 3A-3B illustrate examples of physical attack paths, in accordance with certain embodiments. The physical attack paths in FIGS. 3A and 3B show a set of application topologies that may embed the attack path 200 of FIG. 2. For instance, as illustrated in FIG. 3A in a cloud deployment 330, an application topology is shown where a container 325 provides an API service 320 (e.g., api.foo.com/GET). The API service 320 accepts weak authentication 315. The container 325 is exposed to the Internet 305 by way of a transparent API gateway 310. The business logic of the application, once triggered through the poorly protected API, connects with a cloud-based storage service 335 that offers PII data from a data source 340.

A more complex scenario is shown in FIG. 3B. In a data center deployment 365, API service 370 is provided to the Internet 345 by containers 360 via an API gateway 355. The container 360a accepts weak authentication 350 tokens (e.g., bearer tokens, or JSON web tokens with simple passwords), reaching into a first API service 370a (e.g., api.xyz.com/GET) and then trampolining into a second API service 370b (e.g., api.foo.com/GET). The second API service 370b just happens to serve PII data 380 from a remote storage device. Both physical attack paths can be represented by the logical attack path 200 from FIG. 2. As shown, an attack path can be embedded in many different application topologies.

In certain embodiments, there can be a direct relation between the likelihood of a logical attack path existing in the application and the calculated probability through inference. When the machine-learning model 150 of FIG. 1 indicates a low-value inference probability, the referenced logical attack path may match poorly with the training set. Thus, the logical attack path may not be likely to exist in the application. On the other hand, if there is a high calculated inference probability, the likelihood of a logical attack path being present in the application topology can also be considered high.

As such, the embodiments disclosed herein train the machine-learning model 150 based on already-known or newly crafted attack paths. Inferences of physical attack paths (e.g., finding attack paths in applications) and translating those to logical attack paths may proceed by submitting these application topologies to the machine-learning model 150 (e.g., a transformer model). Using modeling techniques, the machine-learning model 150 disclosed herein can encode the relationship between logical and physical attack paths.

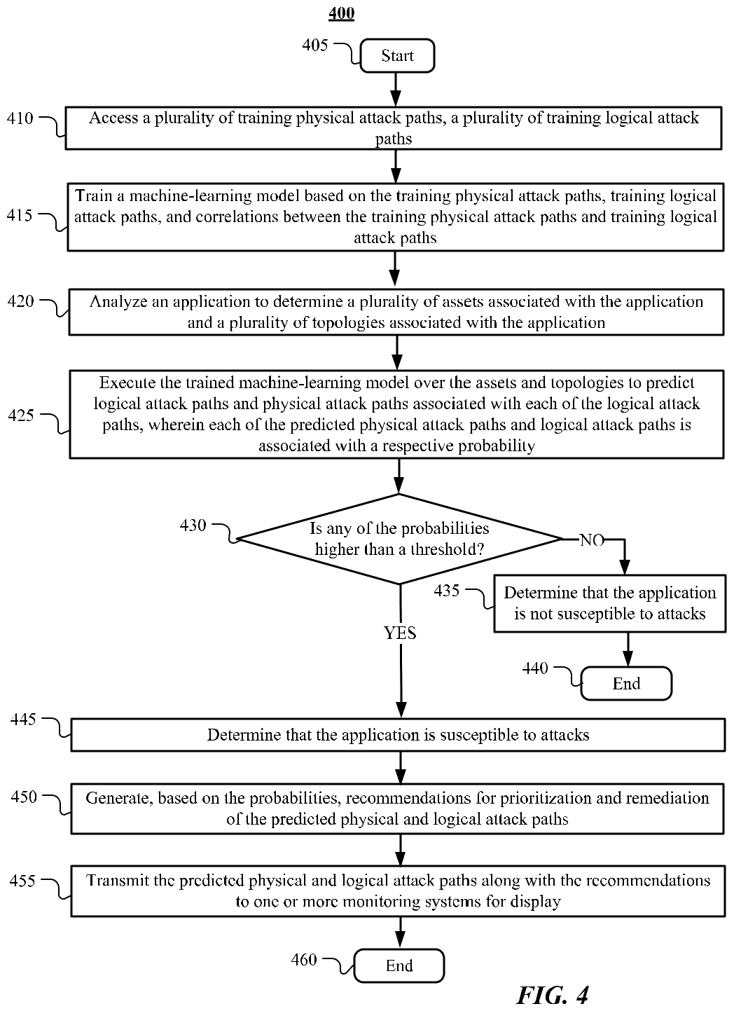

FIG. 4 illustrates a method 400 for training a machine-learning model and using the trained machine-learning model to predict attack paths, in accordance with certain embodiments. Method 400 of FIG. 4 includes the following steps. Method 400 starts at step 405.

At step 410 of method 400, a security system may access a plurality of training physical attack paths and a plurality of training logical attack paths.

At step 415 of method 400, the security system may train a machine-learning model based on the training physical attack paths, training logical attack paths, and correlations between the training physical attack paths and training logical attack paths.

At step 420 of method 400, the security system may analyze an application to determine a plurality of assets associated with the application and a plurality of topologies associated with the application.

At step 425 of method 400, the security system may execute the trained machine-learning model over the assets and topologies to predict one or more physical attack paths and a logical attack path. Each of the predicted physical attack paths and logical attack path is associated with a respective probability.

At step 430 of method 400, the security system may determine whether any of the probabilities are higher than a threshold. If none of the probabilities are higher than the threshold, method 400 proceeds to step 435.

At step 435 of method 400, the security system may determine that the application is not susceptible to attacks. Method 400 then ends at step 440.

If any of the probabilities are higher than the threshold, method 400 proceeds to step 445. At step 445 of method 400, the security system may determine that the application is susceptible to attacks.

At step 450 of method 400, the security system may generate, based on the calculated probabilities, recommendations for prioritization and remediation of the predicted physical and logical attack paths.

At step 455 of method 400, the security system may transmit the predicted physical and logical attack paths along with the recommendations to one or more monitoring systems for display. Method 400 ends at step 460.

Although this disclosure describes and illustrates particular steps of method 400 of FIG. 4 as occurring in a particular order, this disclosure contemplates any suitable steps of method 400 of FIG. 4 occurring in any suitable order. Although this disclosure describes and illustrates an example method for training a machine-learning model and using the trained machine-learning model to predict attack paths including the particular steps of method 400 of FIG. 4, this disclosure contemplates any suitable method for training a machine-learning model and using the trained machine-learning model to predict attack paths including any suitable steps, which may include all, some, or none of the steps of method 400 of FIG. 4, where appropriate. Furthermore, although FIG. 4 describes and illustrates particular components, devices, or systems carrying out particular actions, this disclosure contemplates any suitable combination of any suitable components, devices, or systems carrying out any suitable actions.

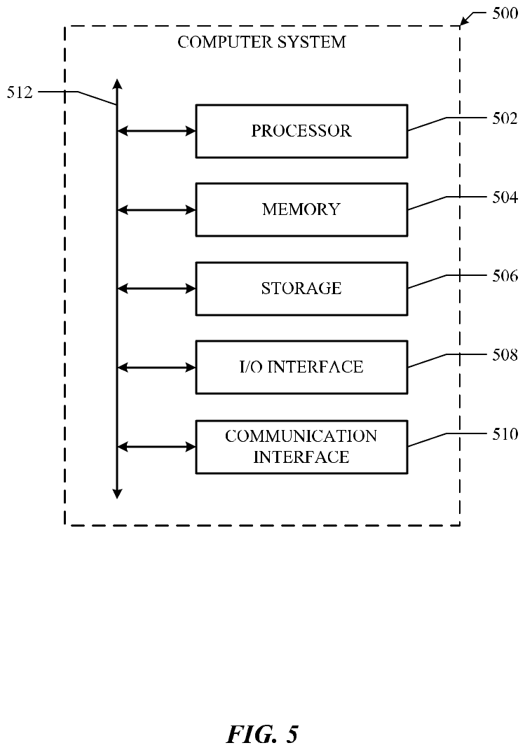

FIG. 5 illustrates a computer system 500, in accordance with certain embodiments. In particular embodiments, one or more computer system 500 perform one or more steps of one or more methods described or illustrated herein. In particular embodiments, one or more computer system 500 provide functionality described or illustrated herein. In particular embodiments, software running on one or more computer system 500 performs one or more steps of one or more methods described or illustrated herein or provides functionality described or illustrated herein. Particular embodiments include one or more portions of one or more computer system 500. Herein, reference to a computer system may encompass a computing device, and vice versa, where appropriate. Moreover, reference to a computer system may encompass one or more computer systems, where appropriate.

This disclosure contemplates any suitable number of computer system 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer system 500; be unitary or distributed; span multiple locations; span multiple machines; span multiple data centers; or reside in a cloud, which may include one or more cloud components in one or more networks. Where appropriate, one or more computer system 500 may perform without substantial spatial or temporal limitation one or more steps of one or more methods described or illustrated herein. As an example, and not by way of limitation, one or more computer system 500 may perform in real time or in batch mode one or more steps of one or more methods described or illustrated herein. One or more computer system 500 may perform at different times or at different locations one or more steps of one or more methods described or illustrated herein, where appropriate.

In particular embodiments, computer system 500 includes a processor 502, a memory 504, a storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer system 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments disclosed herein include a method, an apparatus, a storage medium, a system and a computer program product, wherein any feature mentioned in one category, e.g., a method, can be applied in another category, e.g., a system, as well.

What is claimed is:

1. A system, comprising:
one or more processors; and
one or more computer-readable non-transitory storage media comprising instructions that, when executed by the one or more processors, cause one or more components of system to perform operations comprising:
analyzing an application to determine a plurality of assets associated with the application and a plurality of topologies associated with the application;
executing a machine-learning model over the plurality of assets and the plurality of topologies to predict one or more logical attack paths and one or more physical attack paths associated with each of the one or more logical attack paths, wherein the predicted one or more physical attack paths associated with each of the one or more predicted logical attack paths map to that predicted logical attack path, wherein each of the predicted one or more physical attack paths comprises a respective set of physical assets of the application that can be used in a real-world attack, wherein each of the predicted one or more logical attack paths comprises a sequence of logical steps of the real-world attack, and wherein the machine-learning model was trained based on a plurality of training physical attack paths, a plurality of training logical attack paths, and correlations between the plurality of training physical attack paths and the plurality of training logical attack paths; and
transmitting the predicted one or more logical attack paths and the predicted one or more physical attack paths associated with each of the predicted one or more logical attack paths to one or more monitoring systems for display.

2. The system of claim 1, wherein each of the predicted one or more physical attack paths and the predicted one or more logical attack paths is associated with a respective probability inferred by the machine-learning model.

3. The system of claim 2, the operations further comprising:
generating, by the machine-learning model based on the respective probability associated with each of the predicted one or more physical attack paths and the predicted one or more logical attack paths, a recommendation for prioritizing one or more of the predicted one or more physical attack paths and the predicted one or more logical attack paths.

4. The system of claim 2, the operations further comprising:
generating, by the machine-learning model based on the respective probability associated with each of the predicted one or more physical attack paths and the predicted one or more logical attack paths, a recommendation for remediating one or more of the predicted one or more physical attack paths and the predicted one or more logical attack paths.

5. The system of claim 1, wherein the plurality of training physical attack paths and the plurality of training logical attack paths comprise a plurality of pre-calculated attack paths and a plurality of auto-generated attack paths, the operations further comprising:
generating the plurality of pre-calculated attack paths based on analyses of vulnerabilities associated with a plurality of applications;
generating the plurality of auto-generated attack paths based on public sources; and
determining correlations between the plurality of pre-calculated attack paths and the plurality of auto-generated attack paths, wherein the correlations between the plurality of training physical attack paths and the plurality of training logical paths comprise the correlations between the plurality of pre-calculated attack paths and the plurality of auto-generated attack paths.

6. The system of claim 1, wherein:
the predicted one or more logical attack paths comprises a first logical attack path and one or more second logical attack paths,
the first logical attack path comprises a first sequence of logical steps,
each of the second logical attack paths comprises a respective second sequence of logical steps, at least one of the logical steps between any two second sequences of logical steps being different,
at least one of the logical steps of the first sequence of logical steps and one of each second sequence of logical steps are a same logical step, and
a combination of the logical steps of the second sequences of logical steps comprises the logical steps of the first sequence of logical steps.

7. A method, comprising:
analyzing an application to determine a plurality of assets associated with the application and a plurality of topologies associated with the application;
executing a machine-learning model over the plurality of assets and the plurality of topologies to predict one or more logical attack paths and one or more physical attack paths associated with each of the one or more logical attack paths, wherein the predicted one or more physical attack paths associated with each of the one or more predicted logical attack paths map to that predicted logical attack path, wherein each of the predicted one or more physical attack paths comprises a respective set of physical assets of the application that can be used in a real-world attack, wherein each of the predicted one or more logical attack paths comprises a sequence of logical steps of the real-world attack, and wherein the machine-learning model was trained based on a plurality of training physical attack paths, a plurality of training logical attack paths, and correlations between the plurality of training physical attack paths and the plurality of training logical attack paths; and
transmitting the predicted one or more logical attack paths and the predicted one or more physical attack paths associated with each of the predicted logical attack paths to one or more monitoring systems for display.

8. The method of claim 7, wherein each of the predicted one or more physical attack paths and the predicted one or more logical attack paths is associated with a respective probability inferred by the machine-learning model.

9. The method of claim 7, further comprising:
generating, by the machine-learning model based on the respective probability associated with each of the predicted one or more physical attack paths and the predicted one or more logical attack paths, a recommendation for prioritizing one or more of the predicted one or more physical attack paths and the predicted one or more logical attack paths.

10. The method of claim 7, further comprising:
generating, by the machine-learning model based on the respective probability associated with each of the predicted one or more physical attack paths and the predicted one or more logical attack paths, a recommendation for remediating one or more of the predicted one or more physical attack paths and the predicted one or more logical attack paths.

11. The method of claim 7, wherein the plurality of training physical attack paths and the plurality of training logical attack paths comprise a plurality of pre-calculated attack paths and a plurality of auto-generated attack paths, the method further comprising:
generating the plurality of pre-calculated attack paths based on analyses of vulnerabilities associated with a plurality of applications;
generating the plurality of auto-generated attack paths based on public sources; and
determining correlations between the plurality of pre-calculated attack paths and the plurality of auto-generated attack paths, wherein the correlations between the plurality of training physical attack paths and the plurality of training logical paths comprise the correlations between the plurality of pre-calculated attack paths and plurality of the auto-generated attack paths.

12. The method of claim 7, wherein:
the predicted one or more logical attack paths comprises a first logical attack path and one or more second logical attack paths,
the first logical attack path comprises a first sequence of logical steps,
each of the second logical attack paths comprises a respective second sequence of logical steps, at least one of the logical steps between any two second sequences of logical steps being different,
at least one of the logical steps of the first sequence of logical steps and one of each second sequence of logical steps are a same logical step, and
a combination of the logical steps of the second sequences of logical steps comprises the logical steps of the first sequence of logical steps.

13. A non-transitory computer-readable medium comprising instructions that are configured, when executed by a processor, to:
analyze an application to determine a plurality of assets associated with the application and a plurality of topologies associated with the application;
execute a machine-learning model over the plurality of assets and the plurality of topologies to predict one or more logical attack paths and one or more physical attack paths associated with each of the one or more logical attack paths, wherein the predicted one or more physical attack paths associated with each of the one or more predicted logical attack paths map to that predicted logical attack path, wherein each of the predicted one or more physical attack paths comprises a respective set of physical assets of the application that can be used in a real-world attack, wherein each of the predicted one or more logical attack paths comprises a sequence of logical steps of the real-world attack, and wherein the machine-learning model was trained based on a plurality of training physical attack paths, a plurality of training logical attack paths, and correlations between the plurality of training physical attack paths and the plurality of training logical attack paths; and
transmit the predicted one or more logical attack paths and the predicted one or more physical attack paths associated with each of the predicted logical attack paths to one or more monitoring systems for display.

14. The non-transitory computer-readable medium of claim 13, wherein each of the predicted one or more physical attack paths and the predicted one or more logical attack paths is associated with a respective probability inferred by the machine-learning model.

15. The non-transitory computer-readable medium of claim 13, further comprising instructions that are configured, when executed by the processor, to:
generate, by the machine-learning model based on the respective probability associated with each of the predicted one or more physical attack paths and the predicted one or more logical attack paths, a recommendation for prioritizing one or more of the predicted one or more physical attack paths and the predicted one or more logical attack paths.

16. The non-transitory computer-readable medium of claim 13, further comprising instructions that are configured, when executed by the processor, to:
generate, by the machine-learning model based on the respective probability associated with each of the predicted one or more physical attack paths and the predicted one or more logical attack paths, a recommendation for remediating one or more of the predicted one or more physical attack paths and the predicted one or more logical attack paths.

17. The non-transitory computer-readable medium of claim 13, wherein the plurality of training physical attack paths and the plurality of training logical attack paths comprise a plurality of pre-calculated attack paths and a plurality of auto-generated attack paths, the non-transitory computer-readable medium further comprising instructions that are configured, when executed by the processor, to:
generate the plurality of pre-calculated attack paths based on analyses of vulnerabilities associated with a plurality of applications;
generate the plurality of auto-generated attack paths based on public sources; and
determine correlations between the plurality of pre-calculated attack paths and the plurality of auto-generated attack paths, wherein the correlations between the plurality of training physical attack paths and the plurality of training logical paths comprise the correlations between the plurality of pre-calculated attack paths and the plurality of auto-generated attack paths.

18. The non-transitory computer-readable medium of claim 13, wherein:
the predicted one or more logical attack paths comprises a first logical attack path and one or more second logical attack paths,
the first logical attack path comprises a first sequence of logical steps,
each of the second logical attack paths comprises a respective second sequence of logical steps, at least one of the logical steps between any two second sequences of logical steps being different,
at least one of the logical steps of the first sequence of logical steps and one of each second sequence of logical steps are a same logical step, and
a combination of the logical steps of the second sequences of logical steps comprises the logical steps of the first sequence of logical steps.
